(19) United States
(12) Patent Application Publication
(10) Pub. No.: US 2006/0181574 A1
(43) Pub. Date: Aug. 17, 2006

(54) Method of manufacturing nozzle plate and method of manufacturing liquid droplet ejection head

(75) Inventor: Tsutomu Yokouchi, Ashigara-Kami-Gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/354,153

(22) Filed: Feb. 15, 2006

(30) Foreign Application Priority Data
Feb. 16, 2005 (JP) 2005-039651

(51) Int. Cl. B41J 2/135

(52) U.S. Cl. 347/45

(57) ABSTRACT

The method of manufacturing a nozzle plate, comprises: a filling step of preparing a plate member having a plurality of holes, and filling a filling material into the plurality of holes, the filling material being capable of transmitting radiation; a liquid-repelling film forming step of forming a liquid-repelling film onto a first surface of the plate member such that the liquid-repelling film covers the plurality of holes and periphery thereof; a first irradiating step of irradiating the radiation to the liquid-repelling film through the filling material, from a side of a second surface of the plate member reverse to the first surface, such that portions of the liquid-repelling film corresponding to the plurality of holes are cured or increased in viscosity; a removing step of removing the filling material and only the portions of the liquid-repelling film corresponding to the plurality of holes; and a second irradiating step of irradiating the radiation to a remaining portion of the liquid-repelling film from the side of the first surface, the remaining portion of the liquid-repelling film having not been removed in the removing step, such that the remaining portion of the liquid-repelling film is cured.

### BACKGROUND OF THE INVENTION

1. Field of the Invention

The present invention relates to a manufacturing method for a nozzle plate, and to a method for manufacturing a liquid droplet ejection head, and more particularly, relates to a method for manufacturing a nozzle plate and a method for manufacturing a liquid droplet ejection head having a nozzle surface subjected to a liquid-repelling treatment.

2. Description of the Related Art

An inkjet printer as an image forming apparatus is known, which includes a liquid droplet ejection head or an inkjet head having an arrangement of a plurality of ejection ports or nozzles, and records images on a recording medium by ejecting ink from the nozzles toward a recording medium while causing the inkjet head and the recording medium to move relatively to each other.

As an inkjet head mounted in the inkjet printer, a piezo-type inkjet head is known, in which ink is supplied to a pressure chamber, a portion of which is constituted by a diaphragm provided with a piezoelectric element. When a drive signal corresponding to image data is applied to the piezoelectric element, the piezoelectric element is driven, thereby deforming the diaphragm, reducing the volume of the pressure chamber, and causing the ink inside the pressure chamber to be ejected from a nozzle in the form of an ink droplet.

On the other hand, there are also known thermal jet inkjet heads, which generate bubbles by heating the ink by means of a heater, or other heating element, and eject ink droplets by means of the pressure thereby generated.

In recent years, it has become desirable in inkjet printers to form images of high quality on a par with photographic prints. It has been thought that high image quality can be achieved by reducing the size of the ink droplets ejected from the nozzles by reducing the diameter of the nozzles, while also increasing the number of pixels per unit surface area by arranging the nozzles at high density.

If a liquid-repelling treatment is not provided on the surface of the nozzle plate, in which the nozzles are provided, then ejection abnormalities, such as bending of the direction of flight of the ink droplets ejected from the nozzles may occur, due to ink adhering to the periphery of the nozzles on the surface of the nozzle plate. If the ejection abnormality occurs, then it is not possible to form an image of high quality.

Therefore, various types of manufacturing methods have been proposed for forming a liquid-repelling film on the surface of a nozzle plate.

Japanese Patent Application Publication No. 7-125220 (see FIG. 1, in particular) discloses a method in which a photosensitive resin film is pressed onto the rear surface of a nozzle plate having nozzles while controlling the viscosity by means of the temperature so that a portion of the photosensitive resin film enters into the nozzles, the photosensitive resin film is then cured by irradiation of radiation, a composite plating is then provided on the surface of the nozzle plate to form a liquid-repelling film, and the photosensitive resin film that has entered inside the nozzles is then removed.

Japanese Patent Application Publication No. 2000-108359 (see FIGS. 1 and 2, in particular) discloses a method in which the surface of a nozzle plate having nozzles is covered with a covering material, an ultraviolet-curable filling material is then filled into the nozzles, the filling material is then cured by irradiating ultraviolet light from both sides of the nozzle plate, the covering material is then removed, a liquid-repelling film is then formed on the surface of the nozzle plate, and the filling material, and the like, inside the nozzles is then removed.

Even if the surface of the nozzle plate has been subjected to a liquid-repelling treatment, an ejection abnormality, such as bending of the direction of flight of the ink droplets, may arise if the liquid-repelling treatment is not uniform about the periphery of the nozzles. If the ejection abnormality occurs, then it is not possible to form an image of high quality.

More specifically, when a liquid-repelling film is formed on the surface of a nozzle plate in which nozzles are formed, a filling material is filled into the nozzles, and the filling material is removed after forming the liquid-repelling film. Since the liquid-repelling film 71 adheres onto the filling material 81 filled in the nozzles 51 of the nozzle plate 70 as shown in FIG. 8A, then when it is attempted to mechanically remove the filling material 81, a burr 711 and a chip 712 occur in the vicinity of the nozzles 51 as shown in FIG. 8B, and these can lead to ejection abnormalities.

The methods described in Japanese Patent Application Publication Nos. 7-125220 and 2000-108359 do not refer to the defects of mechanically removing the filling material 81.

### SUMMARY OF THE INVENTION

The present invention has been contrived in view of the foregoing circumstances, an object thereof being to provide a method of manufacturing a nozzle plate, and a method of manufacturing a liquid droplet ejection head, whereby occurrence of burrs and chips in the vicinity of the nozzles can be prevented on the surface of the nozzle plate.

In order to attain the aforementioned object, the present invention is directed to a method of manufacturing a nozzle plate, the method comprising: a filling step of preparing a plate member having a plurality of holes, and filling a filling material into the plurality of holes, the filling material being capable of transmitting radiation; a liquid-repelling film forming step of forming a liquid-repelling film onto a first surface of the plate member such that the liquid-repelling film covers the plurality of holes and periphery thereof; a first irradiating step of irradiating the radiation to the liquid-repelling film through the filling material, from a side of a second surface of the plate member reverse to the first surface, such that portions of the liquid-repelling film corresponding to the plurality of holes are cured or increased in viscosity; a removing step of removing the filling material and only the portions of the liquid-repelling film corresponding to the plurality of holes; and a second irradiating step of irradiating the radiation to a remaining portion of the liquid-repelling film from the side of the first surface, the remaining portion of the liquid-repelling film having not been removed in the removing step, such that the remaining portion of the liquid-repelling film is cured.

According to the present invention, in the first irradiating step, the portions of the liquid-repelling film corresponding to the holes are cured or increased in viscosity through the filling material filled in the holes (nozzles), by using the nozzle plate itself as a mask, and in the filling material removing step, only the portions of the liquid-repelling film corresponding to the nozzles which have been cured or increased in viscosity are removed, together with the filling material. Therefore, even if the filling material filled in the nozzles is mechanically removed, no burrs or chips are produced on the surface of the nozzle plate when the filling material is removed.

Preferably, the liquid-repelling film is made of a material which is cured by one of a photosensitive action and a thermosensitive action when irradiated with the radiation.

Preferably, the radiation irradiated to the liquid-repelling film includes one of visible light, ultraviolet light, infrared light, and an electron beam.

Here, the radiation irradiated to the liquid-repelling film depends on the material used as the liquid-repelling film. For example, ultraviolet light is irradiated to a liquid-repelling film which uses a material having ultraviolet-curable properties. Furthermore, in the case of a liquid-repelling film using a material having thermosetting properties, light of a wavelength that cures the material due to a thermosensitive reaction is irradiated. It is also possible to irradiate laser light of an appropriate single wavelength. If the liquid-repelling film uses a material having electron beam curable properties, then an electron beam is irradiated.

Preferably, the method further comprises, after the liquid-repelling film forming step and before the removing step, a third irradiating step of irradiating the radiation to the liquid-repelling film from the side of the first surface such that at least portions of the liquid-repelling film peripheral to the plurality of holes are semi-cured or increased in viscosity, an amount of the radiation irradiated in the third irradiating step being smaller than an amount of the radiation irradiated in the second irradiating step. According to the present invention, it is possible to prevent the liquid-repelling material from drooping into the nozzles.

Preferably, the method further comprises: before the filling step, a protective layer forming step of forming a protective layer on the first surface of the plate member on which the liquid-repelling film is to be formed; and after the filling step and before the liquid-repelling film forming step, a protective layer removing step of removing the protective layer. According to the present invention, the filling material is prevented from projecting from the nozzles, and the liquid-repelling film can be formed in a uniform manner.

Preferably, the method further comprises, after the filling step and before the liquid-repelling film forming step, a polishing step of polishing the first surface of the plate member on which the liquid-repelling film is to be formed such that portions of the filling material projecting beyond the plurality of holes are removed. According to the present invention, the surface of the nozzle plate becomes flat, and therefore the liquid-repelling film can be formed in a uniform manner.

In order to attain the aforementioned object, the present invention is also directed to a method of manufacturing a liquid droplet ejection head which ejects liquid droplets, the method comprising a step of bonding the nozzle plate manufactured by the above-described manufacturing method to a structural body having channels or liquid chambers to be connected to the plurality of holes in the nozzle plate. According to the present invention, it becomes possible readily to manufacture a liquid droplet ejection head capable of ejecting liquid droplets stably.

According to the present invention, when providing the liquid-repelling treatment on the nozzle plate, it is possible to prevent the occurrence of burrs or chips on the surface of the nozzle plate, in the vicinity of the nozzles.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a plan view perspective diagram of an example of a liquid droplet ejection head manufactured by a liquid droplet ejection head manufacturing method according to an embodiment of the present invention;

FIG. 2 is a cross-sectional diagram along line 2-2 in FIG. 1;

FIGS. 3A to 3F are diagrams showing an example of the basic process of the liquid droplet ejection head manufacturing method;

FIG. 4 is an illustrative diagram used to describe a step of irradiating light onto both the front surface and the rear surface of a nozzle plate;

FIGS. 5A to 5C are illustrative diagrams used to describe a case where filling is performed after forming a protective layer;

FIGS. 6A and 6B are illustrative diagrams used to describe a step of polishing the front surface of the nozzle plate in such a manner that the filling material projecting from the nozzles is removed;

FIG. 7 is an illustrative diagram used to describe a step of bonding a nozzle plate having been subjected to the liquid-repelling treatment, onto a structural body; and

FIGS. 8A and 8B are illustrative diagrams used to describe the occurrence of burrs and chips in the related art.

### DETAILED DESCRIPTION OF THE PREFERRED EMBODIMENTS

FIG. 1 is a plan view perspective diagram showing an example of the structure of a liquid droplet discharge head 50 manufactured by means of the method according to an embodiment of the present invention.

In FIG. 1, the liquid droplet ejection head 50 comprises a plurality of nozzles 51 arranged through a length exceeding at least one of the edges of the maximum size of recording paper.

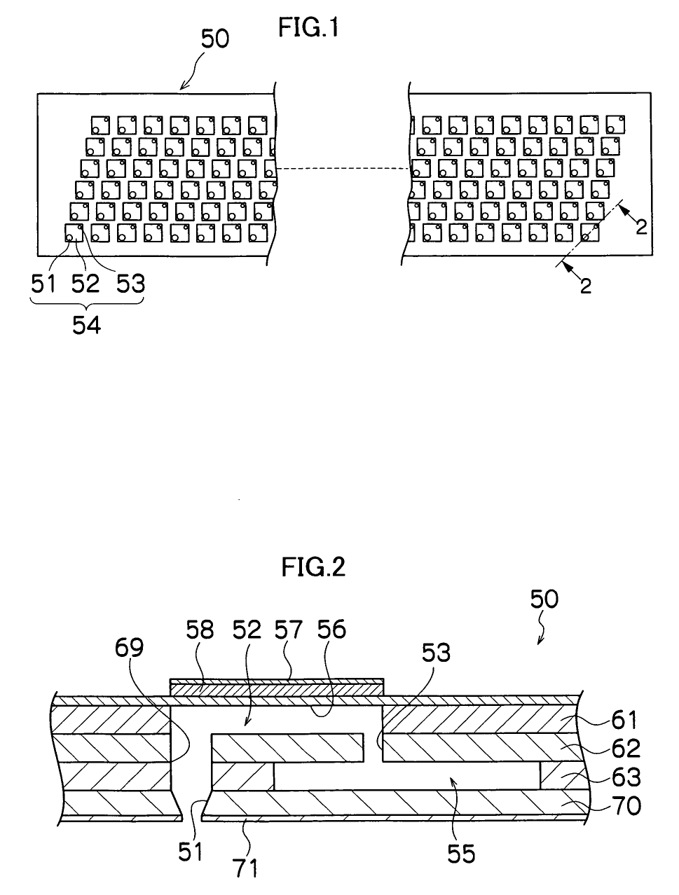

More specifically, in the liquid droplet ejection head 50, a plurality of pressure chamber units 54 are arranged in a two-dimensional matrix. Each of the pressure chamber unit 54 has a nozzle 51 for discharging droplets of ink, a pressure chamber 52 for applying pressure to the ink in order to eject a droplet of the ink through the nozzle 51, and an ink supply port 53 for supplying the ink to the pressure chamber 52 from a common flow channel 55 (shown in FIG. 2).

In the example shown in FIG. 1, the planar shape of each pressure chamber 52 when viewed from above is substantially square. The nozzle 51 is formed at one end of the diagonal of each pressure chamber unit 54, and an ink supply port 53 is provided at the other end thereof.

This description relates to the example where the planar shape of the pressure chambers 52 when viewed from above is substantially square as shown in FIG. 1; however, the present invention is not limited to cases where the planar shape of the pressure chamber 52 is shape.

FIG. 2 shows a cross-sectional view along line 2-2 in FIG. 1.

In FIG. 2, the liquid droplet ejection head 50 has a diaphragm 56 disposed on pressure chambers 52, which apply pressure to the ink when ejecting the ink droplets, and piezoelectric elements 58 forming pressure generating devices for generating the pressure, disposed on top of the diaphragm 56. The diaphragm 56 transmits the pressure generated by the piezoelectric elements 58 to the pressure chambers 52. Furthermore, the diaphragm 56 also serves as a common electrode. Each piezoelectric element 58 is sandwiched between the common electrode or the diaphragm 56, and an individual electrode 57 disposed directly on top of the piezoelectric element 58.

The diaphragm 56 is formed as a single plate, which is common to all of the pressure chambers 52. The piezoelectric elements 58 for deforming the pressure chambers 52 are disposed in a one-to-one correspondence with the pressure chambers 52, at positions on the diaphragm 56 which correspond to the pressure chambers 52. A pair of electrodes (the common electrode and the individual electrode) for driving each of the piezoelectric elements 58 by applying voltage to the piezoelectric element 58 are formed on the upper and lower surfaces of the piezoelectric element 58, thereby sandwiching the piezoelectric element 58.

FIG. 2 only shows the nozzle 51, pressure chamber 52, ink supply port 53, individual electrode 57, piezoelectric element 58, and independent ejection flow channel 69, as single items respectively, but in actual fact, a plurality of each are formed in the liquid droplet ejection head 50.

The liquid droplet ejection head 50 has a structure in which a nozzle plate 70, a common flow channel plate 63, an ink supply port plate 62, a pressure chamber plate 61, and the diaphragm, are laminated in this order, from the bottom upward in FIG. 2. The plurality of nozzles 51 are formed in the nozzle plate 70; the common flow channel 55 and the plurality of independent ejection flow channels 69, which connect one of the plurality of pressure chambers 52 to one of the plurality of nozzles 51, are formed in the common flow channel plate 63; the plurality of ink supply ports 53, which connect the common flow channel 55 to the plurality of pressure chambers 52, and the independent ejection flow channels 69, are formed in the ink supply port plate 62; and the plurality of pressure chambers 52 are formed in the pressure chamber plate 61.

A liquid-repelling film 71 containing a liquid-repelling component, such as fluorocarbon resin, is formed about the periphery of each nozzle 51 in the nozzle plate 70.

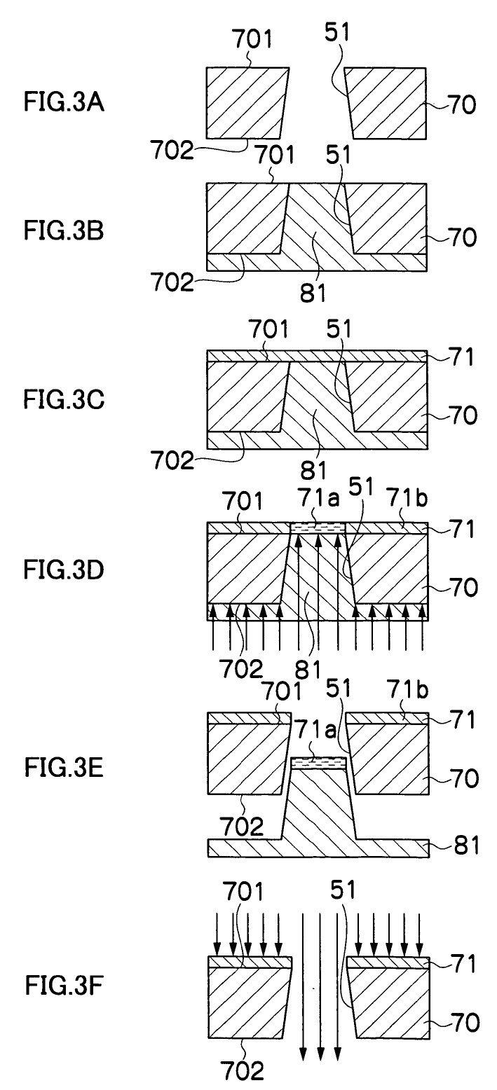

FIGS. 3A to 3F are illustrative diagrams showing an example of a basic manufacturing process for a nozzle plate in the manufacturing method of the liquid droplet ejection head 50.

Firstly, as shown in FIG. 3A, a prescribed plate member 70 is prepared and a plurality of nozzles 51 (holes) are formed in the plate member 70. The plate member 70 in which these nozzles 51 are formed is referred to as the “nozzle plate”.

Needless to say, if a nozzle plate 70 having been formed with a plurality of nozzles 51 can be prepared, then it is sufficient simply to prepare such a plate, and the step of forming nozzles 51 as shown in FIG. 3A can be omitted in the manufacturing method of the liquid droplet ejection head 50.

In order to distinguish clearly and readily between the face of the nozzle plate 70 on which a liquid-repelling film is to be formed, and the other face, hereinafter, the face on which the liquid-repelling film is to be formed (the face on the side where liquid droplets are ejected from the nozzles 51 toward a recording medium, also called the “nozzle surface”) of the nozzle plate 70 is referred to simply as the “front surface” 701, and the face on the opposite side to this front surface (the face on the side where filling material is filled in; also called the “filling surface”) is referred to as the “rear surface” 702.

Next, as shown in FIG. 3B, filling material 81 is filled into the nozzles 51 from the rear surface 702 of the nozzle plate 70.

The filling material 81 must transmit the radiation required to cure a liquid-repelling film, which is described hereinafter. Here, the radiation is ultraviolet light, visible light, infrared light, an electron beam, or the like. For example, if an ultraviolet-curable material is used as the liquid-repelling film, then a material that transmits at least ultraviolet light is used as the filling material 81. If, on the other hand, a thermosetting material is used as the liquid-repelling film, then a material that transmits at least light of the wavelength suitable for this thermosetting is used as the filling material 81. Furthermore, for example, if a material that is cured by reaction with an electron beam is used for the liquid-repelling film, then a material that transmits at least the electron beam is used as the filling material 81.

The filling material 81 is used that has a thickness allowing transmission of sufficient radiation in order to cure the liquid-repelling film.

In the present embodiment, a transparent material which transmits light is used for the filling material 81.

In the present embodiment, a sheet-shaped member having a resin base member is used for the filling material 81. Filling is performed by pressing the sheet of the filling material against the rear surface 702 of the nozzle plate 70. For example, the sheet of the filling material is a urethane-based dry film resist. When using the sheet-shaped filling material 81 in this way, it is possible to eliminate the filling material readily, by mechanically peeling it away, as described later.

In FIG. 3B, a state is shown in which the exposed face of the filling material 81 is flush with the front surface 701 of the nozzle plate 70; however, it is not limited to having the flat exposed shape, and the filling material 81 can be in an exposed state projecting from the nozzles 51 (forming projections on the front surface 701), or it can be in a recessed state inside the nozzles 51 (forming recess sections in the front surface 701). However, if the filling material 81 projects from the nozzles 51, then it may become difficult to subsequently form the liquid-repelling film uniformly (for example, if the film is formed by spin coating), and therefore, it is desirable to set the filling material 81 to a flat state as shown in FIG. 3B, or a recessed state.

Next, as shown in FIG. 3C, a liquid-repelling film 71 is formed by applying a liquid-repelling material onto the front surface 701 of the nozzle plate 70, in such a manner that the liquid-repelling film 71 covers the nozzles 51 and the periphery thereof.

In the present embodiment, a material having a resin base that is cured by a photosensitive or thermosensitive reaction when irradiated with light is used as the liquid-repelling material.

The photosensitive liquid-repelling material is made, for example, by mixing a fluorocarbon resin and photopolymerization initiator into an epoxy resin.

In the case of a photosensitive liquid-repelling material, according to requirements, it is possible to increase the sensitivity by mixing, within a generally used quantity range, an initiator such as an azide initiator, an acetophenone initiator, or a cationic initiator, a photosensitive material such as a bisazide photosensitive material, or a triazine photosensitive material, or both the photosensitive material and photosensitizer.

If the liquid-repelling film is to be cured by an electron beam, then naturally, a material that is cured by the electron beam is used.

Next, as shown in FIG. 3D, portions 71a of the liquid-repelling film 71 covering the front surface 701 of the nozzle plate 70, which portions correspond to the nozzles 51, are exposed and cured by irradiating light from the rear surface 702 of the nozzle plate 70. In other words, the nozzle plate 70 itself in which the plurality of nozzles 51 are formed is used as a mask, and the portions 71a of the liquid-repelling film 71 over the nozzles 51 are exposed through the transparent filling material 81 filled in the nozzles 51. On the other hand, portions 71b peripheral to the nozzles 51 are not exposed to light.

Needless to say, if the liquid-repelling film is to be cured by an electron beam, then an electron beam is irradiated from the rear surface 702 of the nozzle plate 70.

Next, as shown in FIG. 3E, the filling material 81 filled in the nozzles 51 of the nozzle plate 70 is removed from the nozzle plate 70, together with the portions 71a of the liquid-repelling film 71 directly over the nozzles 51. In the present embodiment, the sheet-shaped filling material 81 is mechanically removed by being peeled away from the nozzle plate 70.

Next, as shown in FIG. 3F, the liquid-repelling film 71 on the front surface 701 of the nozzle plate 70 (in other words, the remaining portion in the periphery of the nozzles 51 that has not been removed) is exposed with light and cured.

Needless to say, if the liquid-repelling film is to be cured by an electron beam, then an electron beam is irradiated to the front surface 701 of the nozzle plate 70.

By means of the manufacturing processing described above with reference to FIGS. 3A to 3F, even if the filling material 81 is removed mechanically by being peeled away from the nozzle plate 70, burrs and chips do not occur on the front surface 701 of the nozzle plate 70, in the vicinity of the nozzles 51.

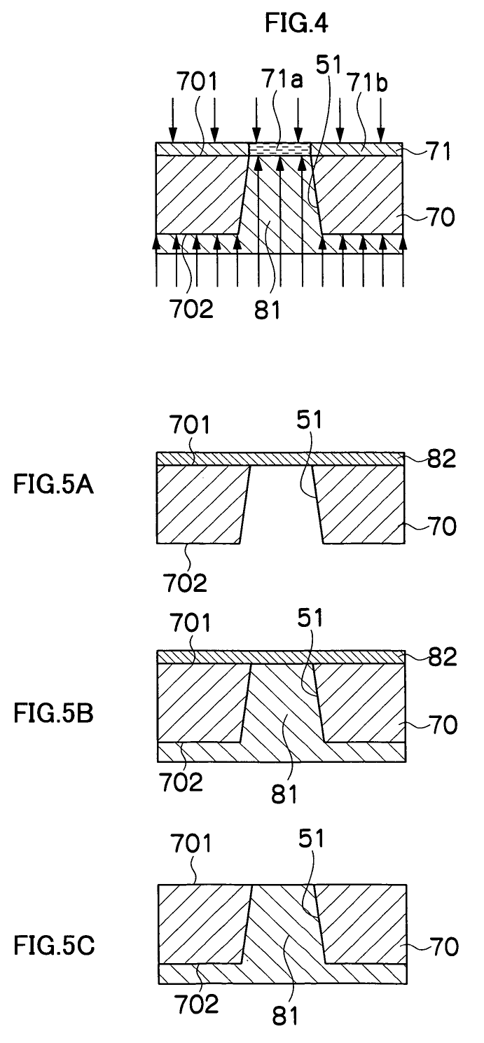

In the basic manufacturing process described above, in the step of exposing the liquid-repelling film 71 through the filling material 81 while using the nozzle plate 70 as the mask, as shown in FIG. 3D, the light is not irradiated to the front surface 701 of the nozzle plate 70; however, as shown in FIG. 4, it is also possible to irradiate light to the front surface 701 of the nozzle plate 70 at the same time as irradiating the light to the rear surface 702 of the nozzle plate 70. In this case, the amount of light irradiated to the front surface 701 is reduced in comparison the light irradiated in the subsequent light exposure step shown in FIG. 3F.

Here, “the amount of irradiated light is reduced” includes a case where the luminance of the irradiated light is made small, and/or a case where the irradiation duration is made short.

By supplementally irradiating the light to the front surface 701 in this way, it is possible to sufficiently cure (or raise the viscosity of) the portions 71 a over the nozzle holes 51, even if sufficient curing of the portions 71a over the nozzle holes 51 is not achieved when the light is only irradiated from the rear surface 702 through the filling material 81.

Although the light is also irradiated to the peripheral sections 71b of the nozzles 51 by the supplemental irradiation, the amount of light is lower than in the subsequent exposure step, and the peripheral sections 71b are not cured completely by this supplemental irradiation, but rather, they are only semi-cured (or increased in viscosity but to a lesser extent than the sections 71a over the nozzles 51). Therefore, similarly to the basic manufacturing processing shown in FIGS. 3A to 3F, a beneficial effect is obtained in that burrs and chips on the front surface 701 of the nozzle plate 70 are prevented when the filling material is removed, and a further beneficial effect is obtained in that the remaining liquid-repelling material is prevented from drooping into the nozzles 51.

FIG. 4 shows an example where the supplemental light irradiation from the front surface 701 side is carried out simultaneously with the light irradiation from the rear surface 702 side, but similar beneficial effects are also obtained if, rather than performing these actions simultaneously, the supplemental light irradiation from the front surface 701 side is carried out either before or after the light irradiation from the rear surface 702 side.

The basic manufacturing process has been described above with respect to an example where, in the step of filling the filling material 81 into the nozzles 51 shown in FIG. 3B, the filling material 81 is filled directly into the nozzles 51 that are in an open state at both the front surface 701 and the rear surface 702 of the nozzle plate 70. However, as shown in FIGS. 5A to 5C, it is also possible to fill the filling material 81 after forming a protective layer 82 on the front surface 701 of the nozzle plate 70.

More specifically, firstly, the protective layer 82 is formed on the front surface 701 of the nozzle plate 70 as shown in FIG. 5A, whereupon the filling material 81 is filled into the nozzles 51 from the side of the rear surface 702 of the nozzle plate 70 as shown in FIG. 5B, and then the protective material 82 is removed from the front surface 701 of the nozzle plate 70 as shown in FIG. 5C.

The protective layer 82 may be formed by bonding a tape-shaped masking material (masking tape) onto the front surface 701.

By filling the filling material 81 after forming the protective layer 82, the filling material 81 is prevented from projecting out beyond the nozzles 51, and therefore, the liquid-repelling film 71 can be uniformly formed when the liquid-repelling film 71 is formed by spin-coating, or the like.

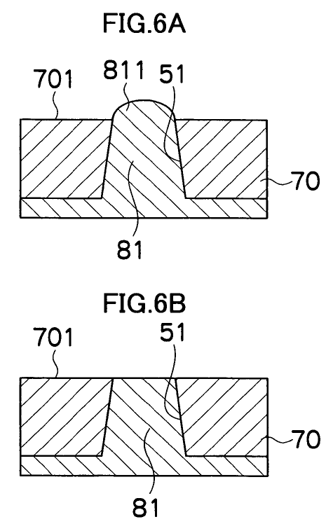

On the other hand, it is also possible to carry out the following procedure: after the step of introducing the filling material 81 into the nozzles 51 as shown in FIG. 3B, portions 811 of the filling material 81 project beyond the nozzles 51 as shown in FIG. 6A, and the projecting portions 811 of the filling material 81 are removed by polishing the front surface 701 of the nozzle plate 70 as shown in FIG. 6B.

If no polishing is carried out and it is sought to fill the filling material 81 in such a manner that the filling material 81 does not project from the nozzles 51, then the amount of filling material 81 that is introduced into the nozzles 51 would inevitably vary between the nozzles 51, whereas if the filling material 81 is filled in such a manner that the filling material 81 projects from the nozzles 51 and the front surface of the nozzle plate 70 is subsequently polished, then the filling can be performed readily even in the case of the sheet-shaped filling material 81, and the front surface 701 of the nozzle plate 70 can be made to have an accurate flat shape. Therefore, the liquid-repelling film 71 can be formed uniformly.

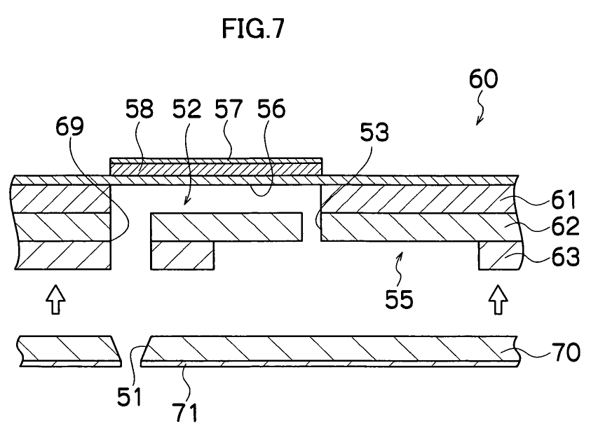

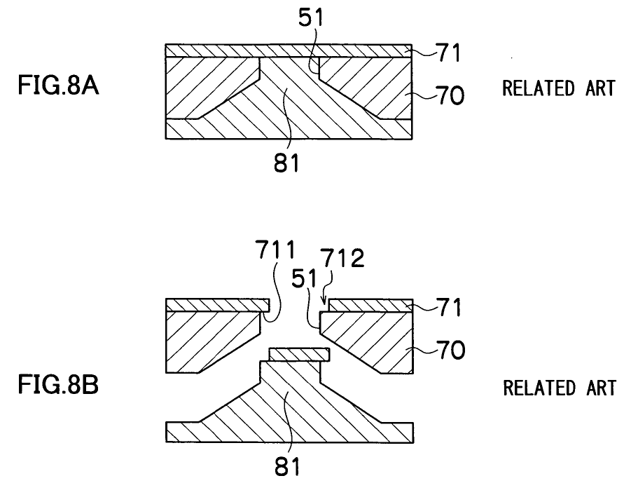

Thus manufactured nozzle plate 70 having the liquid-repelling film 71 formed on the front surface 701 (nozzle surface) thereof is bonded with a structural body 60 formed with the pressure chambers 52, the ink supply ports 53, the common flow channel 55, the diaphragm 56 (which also serves as the common electrode), the individual electrodes 57, the piezoelectric elements 58, and the like, as shown in FIG. 7, thereby forming the liquid droplet ejection head 50 shown in FIGS. 1 and 2.

The foregoing description related to the case where the liquid-repelling film 71 is formed after filling the nozzles 51 by pressing the sheet-shaped filling material 81 onto the nozzle plate 70, whereupon the sheet-shaped filling material 81 is removed by being peeled away from the nozzle plate 70, but the present invention is not limited in particular to a case of this kind. For example, it is also possible to form the protective layer 82 as shown in FIG. 5A, whereupon the liquid filling material is filled in the filling step shown in FIG. 5B, the filling material is then cured, the protective layer 82 is then removed as shown in FIG. 5C, the liquid-repelling film is then formed, and the filling material is then removed mechanically.

Moreover, the radiation irradiated to the liquid-repelling film for curing is not limited to being ultraviolet light, visible light, or infrared light, and it may also be an electron beam.

The foregoing example described the case where the piezoelectric type liquid droplet ejection head 50 is manufactured, but the present invention is not limited to piezo type heads, and may also be used to manufacture a thermal jet type liquid droplet ejection head.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of manufacturing a nozzle plate, the method comprising:
a filling step of preparing a plate member having a plurality of holes, and filling a filling material into the plurality of holes, the filling material being capable of transmitting radiation;
a liquid-repelling film forming step of forming a liquid-repelling film onto a first surface of the plate member such that the liquid-repelling film covers the plurality of holes and periphery thereof;
a first irradiating step of irradiating the radiation to the liquid-repelling film through the filling material, from a side of a second surface of the plate member reverse to the first surface, such that portions of the liquid-repelling film corresponding to the plurality of holes are cured or increased in viscosity;
a removing step of removing the filling material and only the portions of the liquid-repelling film corresponding to the plurality of holes; and
a second irradiating step of irradiating the radiation to a remaining portion of the liquid-repelling film from the side of the first surface, the remaining portion of the liquid-repelling film having not been removed in the removing step, such that the remaining portion of the liquid-repelling film is cured.

2. The method as defined in claim 1, wherein the liquid-repelling film is made of a material which is cured by one of a photosensitive action and a thermosensitive action when irradiated with the radiation.

3. The method as defined in claim 1, wherein the radiation irradiated to the liquid-repelling film includes one of visible light, ultraviolet light, infrared light, and an electron beam.

4. The method as defined in claim 1, further comprising, after the liquid-repelling film forming step and before the removing step, a third irradiating step of irradiating the radiation to the liquid-repelling film from the side of the first surface such that at least portions of the liquid-repelling film peripheral to the plurality of holes are semi-cured or increased in viscosity, an amount of the radiation irradiated in the third irradiating step being smaller than an amount of the radiation irradiated in the second irradiating step.

5. The method as defined in claim 1, further comprising:
before the filling step, a protective layer forming step of forming a protective layer on the first surface of the plate member on which the liquid-repelling film is to be formed; and
after the filling step and before the liquid-repelling film forming step, a protective layer removing step of removing the protective layer.

6. The method as defined in claim 1, further comprising, after the filling step and before the liquid-repelling film forming step, a polishing step of polishing the first surface of the plate member on which the liquid-repelling film is to be formed such that portions of the filling material projecting beyond the plurality of holes are removed.

7. A method of manufacturing a liquid droplet ejection head which ejects liquid droplets, the method comprising a step of bonding the nozzle plate manufactured by the method as defined in claim 1 to a structural body having channels or liquid chambers to be connected to the plurality of holes in the nozzle plate.
